(19) United States
(12) Patent Application Publication
(10) Pub. No.: US 2019/0249842 A1
(43) Pub. Date: Aug. 15, 2019

(54) LIGHT GUIDE COMPONENT, VEHICLE LAMP AND MOTOR VEHICLE

(71) Applicant: Valeo lchikoh (China) Auto Lighting Co. Ltd, Wuhan (CN)

(72) Inventors: Xingang SHI, Foshan City (CN); Zebin NI, Foshan City (CN)

(73) Assignee: Valeo lchikoh (China) Auto Lighting Co. Ltd, Wuhan (CN)

(21) Appl. No.: 16/270,822

(22) Filed: Feb. 8, 2019

(30) Foreign Application Priority Data
Feb. 9, 2018 (CN) 201820241613.8

(51) Int. Cl. F21S 41/24

(52) U.S. Cl. CPC F21S 41/24

(57) ABSTRACT

A light guide component, a vehicle lamp and a motor vehicle are provided. The light guide component includes: a light incidence portion located at a first side of the light guide component facing a light source, and having a first light guiding portion arranged to receive a first portion of an incident light beam and a second light guiding portion arranged to receive a second portion of the incident light beam; a light splitting surface located on a second side of the light guide component opposite to the first side, and arranged in opposite to the light incidence portion; and a light conducting portion located at a peripheral side of the light incidence portion and the light splitting surface, and provided with a light exit surface at the second side of the light guide component. The light splitting surface is arranged to reflect the first portion of the incident light beam guided by the first light guiding portion into the light conducting portion, and to transmit the second portion of the incident light beam guided by the second light guiding portion out of the light guide component from the light splitting surface. The light conducting portion is arranged to direct the first portion of the incident light beam to at least partially exit from the light exit surface.

### TECHNICAL FIELD

The present utility model relates to a light guide component, a vehicle lamp, and a motor vehicle.

### BACKGROUND

The vehicle lamp is an important component of a motor vehicle. The vehicle lamp can provide a lighting function for the motor vehicle, for example, a low beam light, a high beam light, a fog light, etc., and can also provide a signaling function for the motor vehicle, for example, a position light, a brake light, a logo light, etc. Traffic rules and industry standards have specific requirements for light intensity distribution of beams emitted from various vehicle lamps. Therefore, the emitted beams of the vehicle lamp need to be adjusted by an optical system before exiting from the vehicle lamp.

In order to uniform light intensity of the vehicle lamp to obtain a good lighting effect, in the current vehicle lamps, the light emitted by a point light source often needs to be light-distributed by a light guide component before exiting therefrom, to achieve a light emitting effect similar to that of a surface light source. In the current vehicle lamps, it is common to adopt a light guide so that the light beam is incident from one end of the light guide and exits from one side face of the light guide. However, this approach needs to occupy a relatively large space.

### SUMMARY

An object of the present utility model is to provide a light guide component that can increase optical efficiency and reduce space usage.

Another object of the present utility model is to provide a vehicle lamp and a motor vehicle including the above-described light guide component.

The present utility model provides a light guide component, comprising: a light incidence portion located at a first side of the light guide component facing a light source, and having a first light guiding portion arranged to receive a first portion of an incident light beam and a second light guiding portion arranged to receive a second portion of the incident light beam; a light splitting surface located on a second side of the light guide component opposite to the first side, and arranged in opposite to the light incidence portion; and a light conducting portion located at a peripheral side of the light incidence portion and the light splitting surface, and provided with a light exit surface at the second side of the light guide component. The light splitting surface is arranged to reflect the first portion of the incident light beam guided by the first light guiding portion into the light conducting portion, and to transmit the second portion of the incident light beam guided by the second light guiding portion out of the light guide component from the light splitting surface. The light conducting portion is arranged to direct the first portion of the incident light beam to at least partially exit from the light exit surface.

The light splitting surface is arranged such that an incident angle of the first portion of the incident light beam via the first light guiding portion on the light splitting surface is greater than or equal to a total reflection critical angle, and an incident angle of the second portion of the incident light beam via the second light guiding portion on the light splitting surface is less than the total reflection critical angle.

In an embodiment, the light splitting surface is a surface which is concave towards the light incidence portion.

Preferably, the light incidence portion is located at a central region of the first side of the light guide component.

In an embodiment, the second light guiding portion is located at a peripheral side of the first light guiding portion.

In an embodiment, the first light guiding portion has a first transmissive surface which is planar or curved.

In an embodiment, the second light guiding portion has a second transmissive surface and a reflecting surface, the reflecting surface being arranged to reflect the second portion of the incident light beam transmitted through the second transmissive surface towards the light splitting surface.

In an embodiment, the reflecting surface has a profile of cross section in a form of straight line or curved line, or the profile of cross section comprises a plurality of curved line segments.

In an embodiment, the first transmissive surface has an area greater than that of the second transmissive surface. Herein, it should be mentioned that the areas of the first transmissive surface and the second transmissive surface are not limited to the above. The areas of the first transmissive surface and the second transmissive surface should be arranged in such a way that an energy proportion of the incident light beam transmitted through the first transmissive surface to the light splitting surface should be greater than an energy proportion of the incident light beam transmitted through the second transmissive surface to the light splitting surface, thereby the light guide component may be uniformly lighten.

In an embodiment, the light splitting surface has a profile of cross section in a form of straight line or curve line.

In an embodiment, the light guiding portion further comprises a light reflecting portion disposed at the first side of the light guide component, the light reflecting portion being arranged to reflect the first portion of the incident light beam reflected by the light splitting surface towards the light exit surface such that the first portion of the incident light beam is at least partially emitted from the light exit surface.

In an embodiment, the light exit surface is arranged around the light splitting surface, and the light reflecting portion is arranged around the light incidence portion.

In an embodiment, the light reflecting portion is provided with a prism array.

In an embodiment, a plurality of light reflecting portions in form of dots are provided.

In an embodiment, the light reflecting portion comprises protrusions or recesses.

The light reflecting portion is arranged such that the first portion of the incident light beam that is reflected by the light reflecting portion is at least partially directed towards the light exit surface at an incident angle that is less than the total reflection critical angle.

In an embodiment, the light splitting surface and/or the light exit surface is provided with grain.

In an embodiment, the light guide component comprises one or more said light incidence portions and one or more said light splitting surfaces, and the light incidence portions are in one-to-one correspondence with the light splitting surfaces.

The present utility model also provides a vehicle lamp, comprising a light source for emitting an incident light beam; and the light guide component according to any one of the above embodiments. The light source is correspondingly provided for the light incidence portion of the light guide component.

The present utility model also provides a motor vehicle, comprising the light guide component according to any one of the above embodiments or the vehicle lamp described above.

In the light guide component according to the present utility model, by means of the arrangement of the first light guiding portion, the second light guiding portion, and the light splitting surface, the incident light beam can be divided into two portions. One portion is emitted from the light splitting surface, and the other portion is directed to other parts inside the light guide component, thus providing illumination for a larger region. This provides a scheme of expanding an illumination area of the light beam incident from a back side of the light guide component, which can improve optical efficiency and save space.

### BRIEF DESCRIPTION OF THE DRAWINGS

FIG. 1 is a schematic front perspective view of a light guide component according to an embodiment of the present utility model;

FIG. 2 is a schematic back view of a light guide component according to an embodiment of the present utility model;

FIG. 3 is a schematic cross-sectional view of a light guide component according to an embodiment of the present utility model;

FIG. 4 is a schematic top view of a light guide component according to an embodiment of the present utility model;

FIG. 5 schematically illustrates an example of an optical path of a first portion of an incident light beam in a light guide component according to an embodiment of the present utility model;

FIG. 6 schematically illustrates an example of an optical path of a second portion of an incident light beam in a light guide component according to an embodiment of the present utility model;

FIG. 7 schematically illustrates another example of an optical path of a first portion of an incident light beam in a light guide component according to an embodiment of the present utility model;

FIG. 8 schematically illustrates another example of an optical path of a second portion of an incident light beam in a light guide component according to an embodiment of the present utility model;

FIG. 9 schematically illustrates a further example of an optical path of a first portion of an incident light beam in a light guide component according to an embodiment of the present utility model;

FIG. 10 schematically illustrates a further example of an optical path of a second portion of an incident light beam in a light guide component according to an embodiment of the present utility model;

FIG. 11 is a partial schematic perspective view of a light guide component according to another embodiment of the present utility model, viewed from its back side;

FIG. 12 is a partial schematic cross-sectional view of a light guide component according to another embodiment of the present utility model;

FIG. 13 is a schematic perspective view of a light guide component according to a further embodiment of the present utility model;

FIG. 14 is a schematic top view of a light guide component according to a still further embodiment of the present utility model;

FIG. 15 is a schematic perspective view of a light guide component according to a still further embodiment of the present utility model; and

FIG. 16 is a schematic back view of a light guide component according to a still further embodiment of the present utility model.

### DETAILED DESCRIPTION OF EMBODIMENTS

The technical solutions of the present utility model will be further explained in detail with reference to the embodiments in combination with the accompanying drawings. In the specification, like or similar reference numerals indicate like or similar parts. The following description of the embodiments of the present utility model with reference to the accompanying drawings is intended to explain the general inventive concept of the present utility model, but should not be construed as limiting the present utility model.

Further, in the following detailed description, numerous specific details are set forth in order to provide a thorough understanding of the embodiments of the present utility model. However, it will be apparent that one or more embodiments may also be practiced without these specific details.

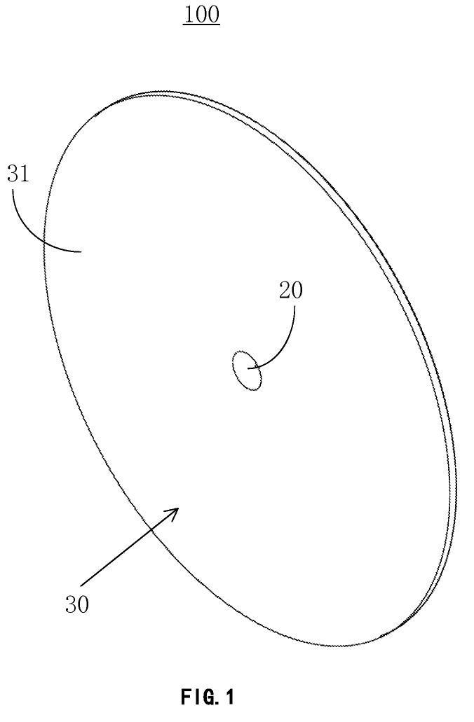

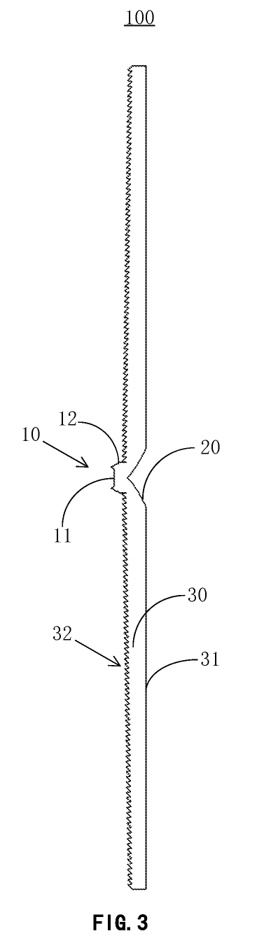

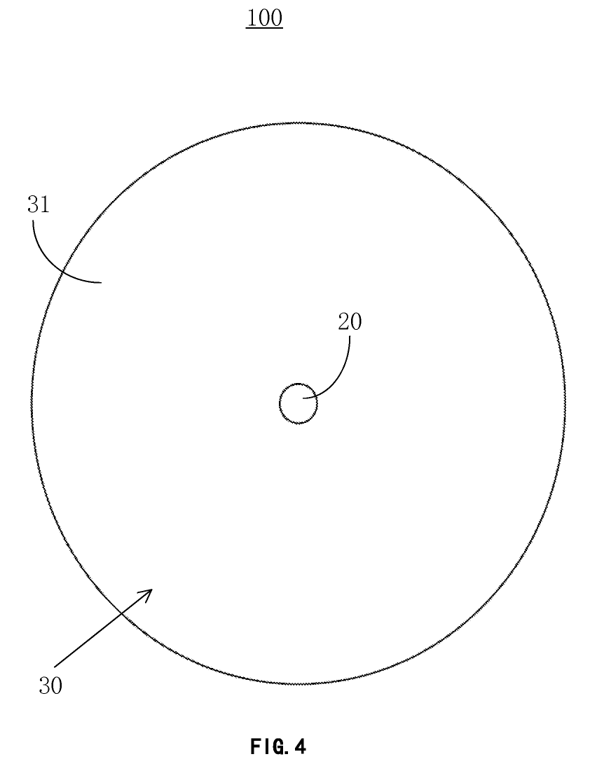

FIGS. 1 to 4 schematically illustrate a light guide component 100 according to an embodiment of the present utility model. In the drawings, light is indicated by thin solid lines. The light guide component 100 may include a light incidence portion 10, a light splitting surface 20, and a light conducting portion 30. The light incidence portion 10 and the light splitting surface 20 are respectively located at two opposite sides of the light guide component 100. For convenience of description, hereinafter, the side at which the light incidence portion 10 is located is referred to as a first side of the light guide component 100, and the side at which the light splitting surface 20 is located is referred to as a second side of the light guide component 100. As shown in FIG. 3, the light splitting surface 20 may be arranged in opposite to the light incidence portion 10. The light conducting portion 30 is located at a peripheral side of the light incidence portion 10 and the light splitting surface 20, and the light conducting portion 30 is provided with a light exit surface 31 at the second side of the light guide component 100. The light incidence portion 10 has a first light guiding portion 11 and a second light guiding portion 12. The first light guiding portion 11 is arranged to receive a first portion 41 of an incident light beam (for example, a central portion of the incident light beam), and the second light guiding portion 12 is arranged to receive a second portion 42 of the incident light beam (for example, a peripheral portion of the incident light beam). The light splitting surface 20 may be arranged to reflect the first portion 41 of the incident light beam guided by the first light guiding portion 11 into the light conducting portion 30, and to transmit the second portion 42 of the incident light beam guided by the second light guiding portion 12 out of the light guide component 100 from the light splitting surface 20. The light conducting portion 30 is arranged to direct the first portion 41 of the incident light beam to at least partially exit from the light exit surface 31 (the first portion 41 of the incident light beam may all exit from the light exit surface 31 or may partially exit from the light exit surface 31). The light splitting surface 20 is disposed in opposite to the light incidence portion 10, which facilitates receiving the first portion 41 of the incident light beam from the first light guiding portion 11 and the second portion 42 of the incident light beam from the second light guiding portion 12.

In the light guide component 100 according to the embodiment of the present utility model, the incident light beam is divided into two portions. The second portion 42 of the incident light beam is directly emitted out from the light splitting surface 20 for illuminating a position in front of the light guide component 100 corresponding to the light exit portion 10, while the first portion 41 of the incident light beam is reflected by the light splitting surface 20 to other parts inside the light guide component 100, for illuminating other positions of a larger area in front of the light guide component 100. If all portions of the incident light beam are directly emitted from the light splitting surface 20, the illumination area of an emergent light of the light guide component 100 would be greatly limited (especially for a point light source). On the other hand, if all portions of the incident light beam are reflected by the light splitting surface 20, a dark area would appear in front of the light guide component 100. In the embodiment of the present utility model, by means of the arrangement of the first light guiding portion 11, the second light guiding portion 12, and the light splitting surface 20, it meets the requirement for expanding the illumination area of the light beam incident from the back side of the light guide component by a point light source. Compared with the existing edge lighting scheme, the embodiment of the present utility model can significantly increase utilization rate of incident light beam emitted from a point light source, and can obtain higher light intensity in case where the number of the point light sources is constant, or achieve the same light intensity with fewer point light sources, thereby reducing cost and saving space.

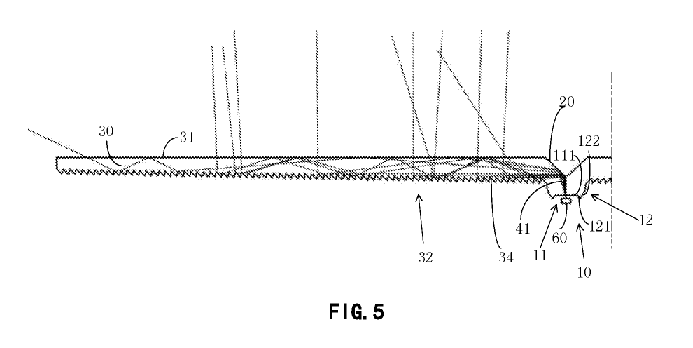

An example of the effect of the light guide component 100 on the first portion 41 of the incident light beam is shown in FIG. 5. In this example, the first light guiding portion 11 has a first transmissive surface 111. The first portion 41 of the incident light beam is guided to the light splitting surface 20 after passing through the first transmissive surface 111, and is reflected into the light conducting portion 30 by the light splitting surface 20 along the light guide component 100 in a direction away from the light incidence portion 10. As an example, in order to achieve reflection of the first portion 41 of the incident light beam on the light splitting surface 20, the light splitting surface 20 may be arranged such that an incident angle of the first portion 41 of the incident light beam via the first light guiding portion 11 on the light splitting surface 20 is greater than or equal to a total reflection critical angle, thereby the light splitting surface 20 totally reflects the first portion 41 of the incident light beam.

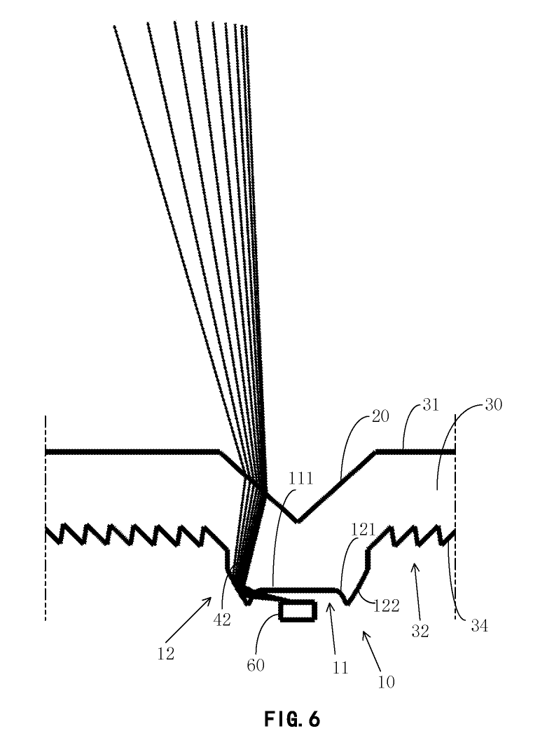

An example of the effect of the light guide component 100 on the second portion 42 of the incident light beam is shown in FIG. 6. In this example, the second light guiding portion 12 has a second transmissive surface 121 and a reflecting surface 122. The reflecting surface 122 is arranged to reflect the second portion 42 of the incident light beam transmitted through the second transmissive surface 121 towards the light splitting surface 20. The second portion 42 of the incident light beam reflected onto the light splitting surface 20 can be transmitted through the light splitting surface 20 to be emitted towards the front of the light guide component 100. As an example, in order to achieve the second portion 42 of the incident light beam to be transmitted through the light splitting surface 20, the light splitting surface 20 may be arranged such that an incident angle of the second portion 42 of the incident light beam via the second light guiding portion 12 on the light splitting surface 20 is less than the total reflection critical angle, thereby avoiding total reflection of the second portion 42 of the incident light beam on the light splitting surface 20.

By means of the total reflection, on the one hand, the optical efficiency can be increased, and on the other hand, by adjusting the incident angles of various portions of the incident light beam on the light splitting surface 20, one portion of the incident light beam can be emitted from the light splitting surface 20 while the other portion of the incident light beam is emitted from the light exit surface 31 to distribute the light intensity.

In an example, the area of the first transmissive surface 111 may be greater than the area of the second transmissive surface 121, which facilitates that more incident light beam is reflected by the light splitting surface 20 and emitted from the light exit surface 31 to distribute light energy on a larger illumination area.

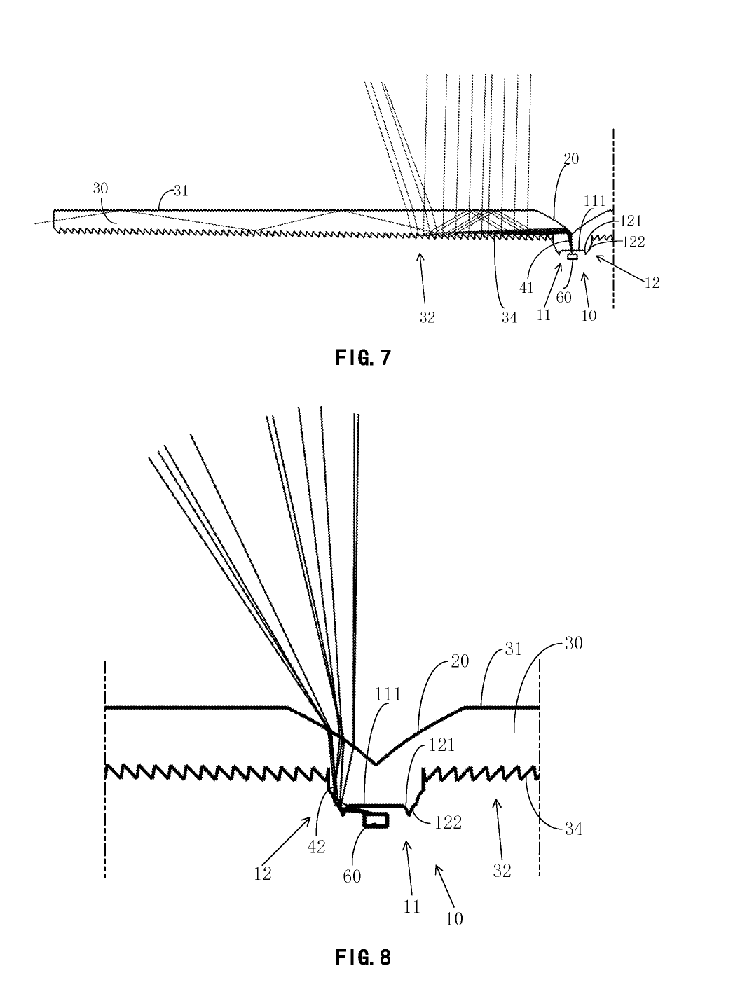

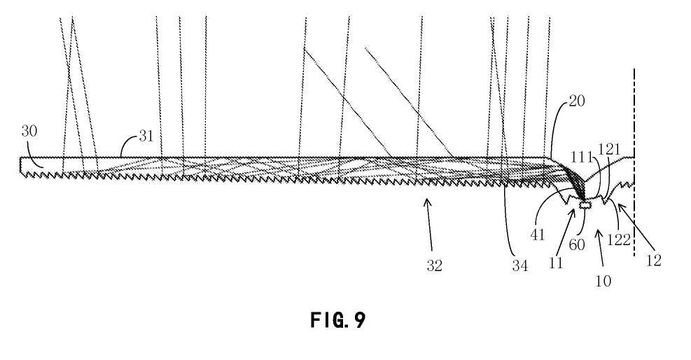

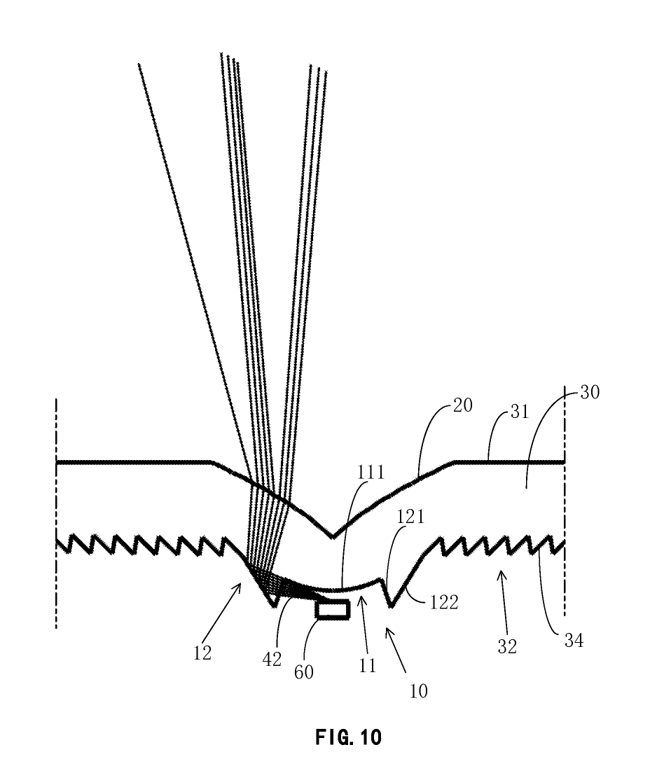

As an example, the first transmissive surface 111 may be in the form of planar surface (as shown in FIGS. 5 to 8) or curved surface (as shown in FIG. 9 or FIG. 10). The first transmissive surface 111 in the form of curved surface can increase the area of the first transmissive surface 111 for receiving light. Similarly, the reflecting surface 122 of the second light guiding portion 12 may have a profile of cross section in the form of straight line (as shown in FIG. 5 or FIG. 6) or in the form of curved line (as shown in FIGS. 7 to 10). In an example, the profile of cross section of the reflecting surface 122 includes a plurality of curved line segments, as shown in FIGS. 7 and 8. This helps to adjust the shape of the light beam emitted from the light splitting surface 20, for example, to make the light intensity distribution of the light beam emitted from the light splitting surface 20 more uniform. As an example, the second light guiding portion 12 may be located at a peripheral side of the first light guiding portion 11, as shown in FIGS. 3, 5 to 10. However, the embodiments of the present utility model are not limited thereto.

In an example, the light splitting surface 20 may be a surface which is concave towards the light incidence portion 10. This is advantageous in saving space and better achieving total reflection function of the light splitting surface 20. In an example, the light splitting surface 20 may have a profile of cross section in the form of straight line (as shown in FIG. 5 or FIG. 6) or in the form of curved line (as shown in FIGS. 7 to 10). This makes it possible to achieve a different distribution of intensity of the light beam emitted from the light exit surface 31.

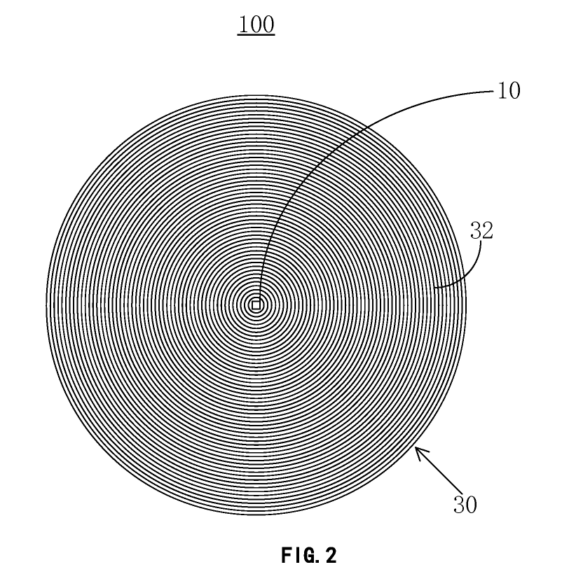

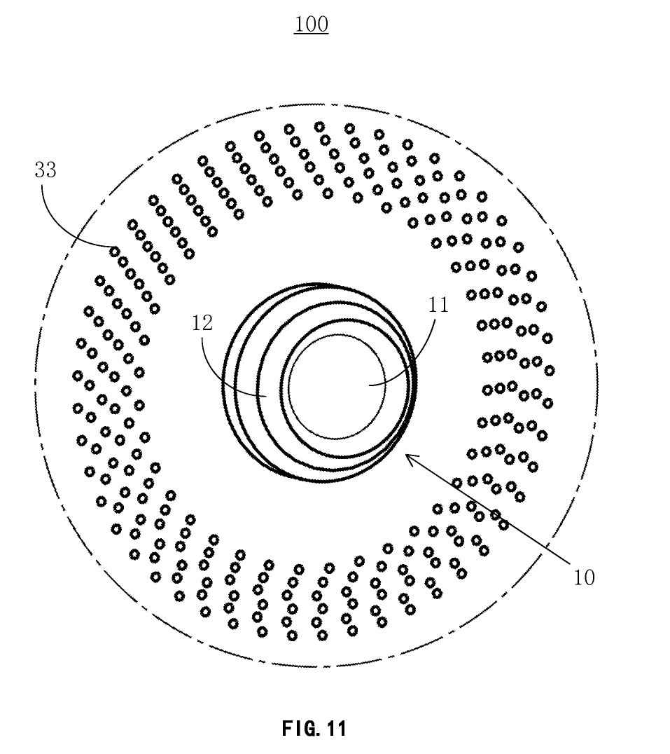

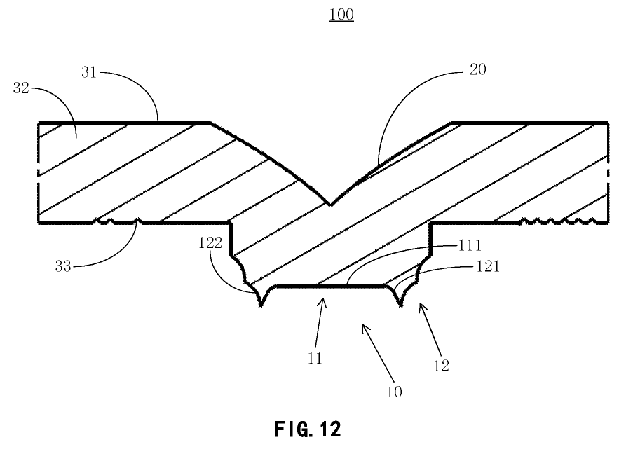

In the light guide component, particularly in the light conducting portion 30, light propagates usually mainly therein in a total reflection manner. In order to enable the first portion 41 of the incident light beam to be emitted from the light exit surface 31, as an example, the light conducting portion 30 may include a light reflecting portion 32 disposed at the first side of the light guide component 100. The light reflecting portion 32 can be arranged to reflect the first portion 41 of the incident light beam reflected by the light splitting surface 20 towards the light exit surface 31 such that the first portion 41 of the incident light beam is at least partially emitted from the light exit surface 31. The light reflecting portion 32 functions to break the total reflection condition of the light beam on the light exit surface 31 of the light guide component 100 by utilizing a change in structure (for example, forming a light reflecting portion such as protrusions or recesses), thereby allowing the first portion 41 of the incident light beam to be emitted from the light exit surface 31. The above-described function of the light reflecting portion 32 may be referred to as a light decoupling effect. As an example, the light reflecting portion 32 may be arranged such that the first portion 41 of the incident light beam reflected by the light reflecting portion 32 is at least partially directed to the light exit surface 31 at an incident angle less than the total reflection critical angle. The light decoupling effect of the light reflecting portion 32 may be realized by the provision of a plurality of light reflecting portions on the light reflecting portion 32. For example, the light reflecting portion 32 may be provided with a prism array 34 as shown in FIGS. 5 and 2. Alternatively, the light reflecting portion 32 may be provided with a plurality of light reflecting portions 33 in the form of dots, as shown in FIGS. 11 and 12. Each of the light reflecting portions 33 may be regarded as one point in the light reflecting portion 32. This distribution in the form of dots facilitates a more uniform light intensity for the light guide component 100. As an example, the light reflecting portion 33 may include protrusions or recesses. As shown in FIGS. 2 and 3, the light incidence portion 10 and the light reflecting portion 32 may be respectively located in different regions at the first side of the light guide component 100.

As an example, the light splitting surface 20 may reflect the first portion 41 of the incident light beam via the first light guiding portion 11 towards at least one of the light reflecting portion 32 and the light exit surface 31. The light reflecting portion 32 may be arranged to reflect the first portion 41 of the incident light beam reflected by the light splitting surface 20 towards the light exit surface 31 such that the first portion 41 of the incident light beam is at least partially emitted from the light exit surface 31.

As an example, as shown in FIGS. 2 and 5, the light exit surface 31 may be disposed around the light splitting surface 20. This makes it possible to achieve a uniform expansion of illumination range of a point light source. As an example, the light reflecting portion 32 may also be disposed around the light incidence portion 10. For example, the light incidence portion 10 may be located in a central region of the first side of the light guide component 100, as shown in FIG. 2. Such an arrangement of the light incidence portion 10 and the light reflecting portion 32 facilitates more fully utilizing the light energy of the incident light beam.

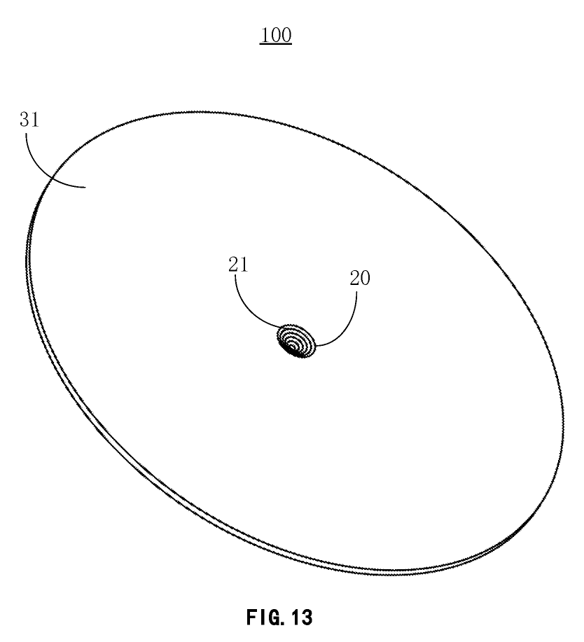

In an example, a grain 21 may be provided on the light splitting surface 20, as shown in FIG. 13. The grain is a texture on a surface (for example, having a ring shape or other shapes, or even a randomly-distributed shape), and is of a light homogenization structure capable of scattering light passing through the surface on which it is located such that the light emitted from the surface can be directed more uniformly in all directions. As an example, the texture may have, for example, a height or depth of 0.01 mm to 0.05 mm, and may have any cross-sectional shape. As an example, a model of the grain such as MT9050 or K5000 may be provided on the light splitting surface 20. This can enhance uniformity of the emergent light. Similarly, the grain may also be provided on other surfaces such as the light exit surface 31.

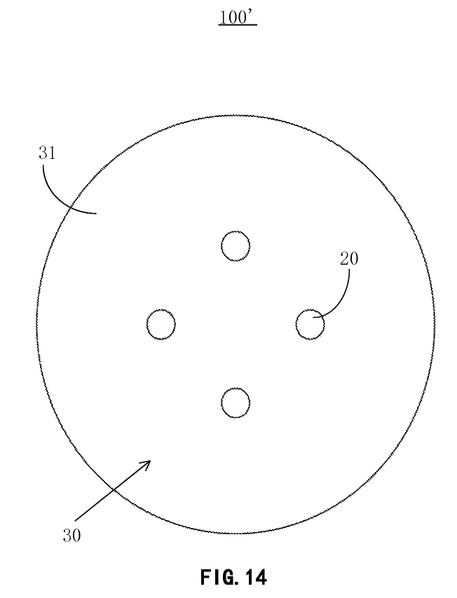

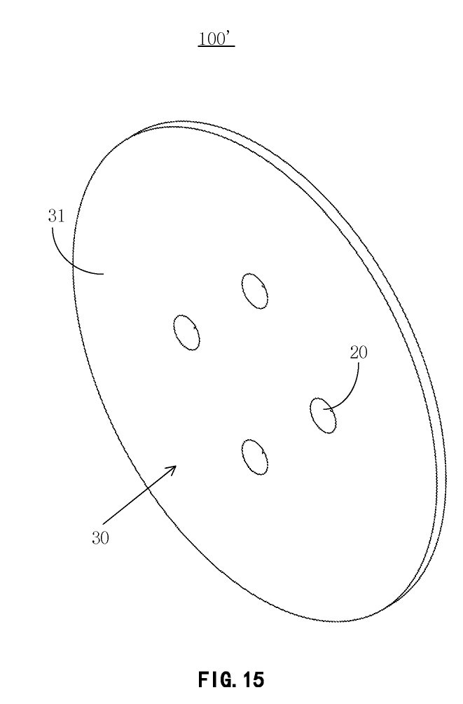

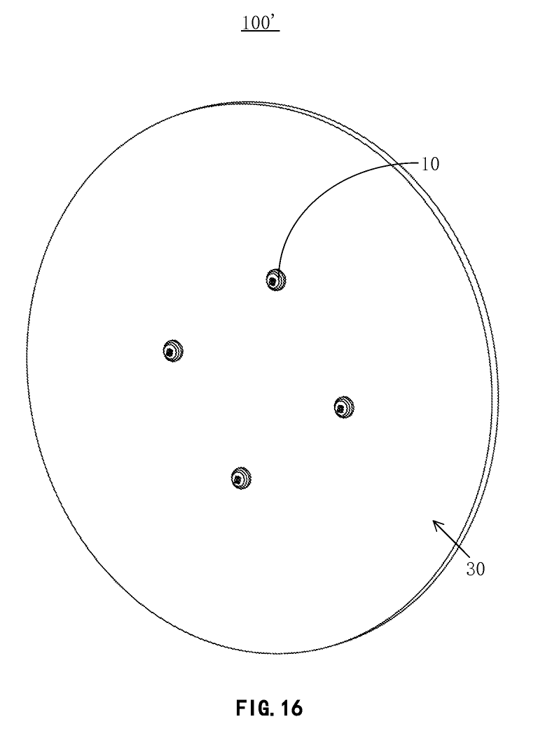

In the embodiments of the present utility model, the light guide component 100 may be provided with one light incidence portion 10, or a plurality of light incidence portions 10. For example, in the embodiment shown in FIGS. 14 to 16, the light guide component 100′ is provided with four light incidence portions 10. Increasing the number of the light incidence portions 10 helps to increase the intensity of the emergent light. Any number of light incidence portions 10, such as one, two, three, four, five, six, seven, eight or more, may be provided in the light guide component 100, 100′ according to the present utility model. Accordingly, the light guide component 100 may also be provided with one or more light splitting surfaces 20. The light splitting surfaces 20 may in one-to-one correspondence with the light incidence portions 10. It should be noted that, since the utilization rate of the incident light beam is increased in the embodiments of the present utility model relative to that in the prior art, it is possible to adopt fewer light sources to obtain a larger intensity of emergent light. Accordingly, the number of the light incidence portions and the light splitting surfaces may be matched to the number of the light sources used with the light guide component 100, 100′. The light reflecting portions are not shown in FIG. 16 in view of display clarity.

Although the light guide components 100, 100′ shown in FIG. 1, FIG. 2, and FIG. 11 to FIG. 16 are all circular plates, the embodiments of the present utility model are not limited thereto, and the light guide components may have any other shapes such as an ellipse or a quadrangle. It may be determined by those skilled in the art as needed. In some embodiments of the present utility model, the light guide components 100, 100′ may have a central symmetrical shape. However, the embodiments of the present utility model are not limited thereto, and for example, they may also have a non-central symmetrical shape.

In the embodiments of the present utility model, the light guide component 100, 100′ may be, for example, of a solid structure, for example, it may be made of a light transmissive material such as resin or plastic, for example, polycarbonate or polymethyl methacrylate. However, the embodiments of the present utility model are not limited thereto.

It should be mentioned that although a disk-shaped light guide component is shown in the drawings, it may be in any other suitable shape, such as a square shape.

The present utility model also provides a vehicle lamp. The vehicle lamp may include a light source 60 for emitting an incident light beam, and the light guide component 100, 100′ according to any one of the above embodiments. As an example, the light guide component 100, 100′ may include at least one light incidence portion 10, and the optical assembly may include at least one light source 60. The at least one light incidence portion 10 is arranged to receive an incident light beam emitted from the at least one light source 60, respectively. Since the light guide component 100, 100′ can be used to achieve uniform expansion of intensity of the illumination area of the point light source, the optical assembly can be used to provide a surface source. This saves cost and reduces space occupied by the system. In an example, the light source 60 may include an LED light source or other light sources known in the art. In case where multiple light sources are employed, the multiple light sources may be arranged in an array. As an example, each of the light sources 60 may be disposed to face one light incidence portion 10 to increase optical efficiency as far as possible.

The vehicle lamp according to the embodiments of the present utility model may include, for example, any type of lamps of a motor vehicle, such as a logo light, a fog light, a central high-mount stop light, a turn light, a position light, a tail brake light, etc., and may also include lights in a vehicle compartment, and so on.

While the present utility model has been described in connection with the accompanying drawings, the embodiments disclosed in the drawings are intended to illustrate the exemplified embodiments of the present utility model and are not to be construed as limiting the present utility model. The scales in the drawings are merely illustrative and are not to be construed as limiting the present utility model.

While some embodiments of the general inventive concept of present utility model have been shown and described, those skilled in the art will appreciate that changes may be made to these embodiments without departing from the principles and spirit of the general inventive concept of the present utility model. The scope of the present utility model is defined by the appended claims and their equivalents.

1. A light guide component, comprising:
a light incidence portion located at a first side of the light guide component facing a light source, and having a first light guiding portion arranged to receive a first portion of an incident light beam and a second light guiding portion arranged to receive a second portion of the incident light beam;
a light splitting surface located on a second side of the light guide component opposite to the first side, and arranged in opposite to the light incidence portion; and
a light conducting portion located at a peripheral side of the light incidence portion and the light splitting surface, and provided with a light exit surface at the second side of the light guide component,
wherein the light splitting surface is arranged to reflect the first portion of the incident light beam guided by the first light guiding portion into the light conducting portion, and to transmit the second portion of the incident light beam guided by the second light guiding portion out of the light guide component from the light splitting surface.

2. The light guide component according to claim 1, wherein the light splitting surface is a surface which is concave towards the light incidence portion.

3. The light guide component according to claim 1, wherein the second light guiding portion is located at a peripheral side of the first light guiding portion.

4. The light guide component according to claim 1, wherein the first light guiding portion has a first transmissive surface which is planar or curved.

5. The light guide component according to claim 1, wherein the second light guiding portion has a second transmissive surface and a reflecting surface, the reflecting surface being arranged to reflect the second portion of the incident light beam transmitted through the second transmissive surface towards the light splitting surface.

6. The light guide component according to claim 5, wherein the reflecting surface has a profile of cross section in a form of straight line or curved line or curved line segments.

7. The light guide component according to claim 5, wherein the first transmissive surface has an area greater than that of the second transmissive surface.

8. The light guide component according to claim 1, wherein the light splitting surface has a profile of cross section in a form of straight line or curve line.

9. The light guide component according to claim 1, wherein the light guiding portion further comprises a light reflecting portion disposed at the first side of the light guide component, the light reflecting portion being arranged to reflect the first portion of the incident light beam reflected by the light splitting surface towards the light exit surface such that the first portion of the incident light beam is at least partially emitted from the light exit surface.

10. The light guide component according to claim 9, wherein the light reflecting portion is provided with a prism array, a dot array, protrusions or recesses.

11. The light guide component according to claim 1, wherein the light splitting surface and/or the light exit surface is provided with grain.

12. The light guide component according to claim 1, wherein the light guide component comprises one or more said light incidence portions and one or more said light splitting surfaces, and the light incidence portions are in one-to-one correspondence with the light splitting surfaces.

13. A vehicle lamp, comprising a light source for emitting an incident light beam; and the light guide component according claim 1.

14. A motor vehicle, comprising the light guide component according to claim 1.

15. A motor vehicle, comprising the vehicle lamp according to claim 13.

16. The light guide component according to claim 2, wherein the light splitting surface and/or the light exit surface is provided with grain.

17. The light guide component according to claim 2, wherein the light guide component comprises one or more said light incidence portions and one or more said light splitting surfaces, and the light incidence portions are in one-to-one correspondence with the light splitting surfaces.

18. A vehicle lamp, comprising a light source for emitting an incident light beam; and the light guide component according claim 2.

19. The light guide component according to claim 3, wherein the light splitting surface and/or the light exit surface is provided with grain.

20. The light guide component according to claim 3, wherein the light guide component comprises one or more said light incidence portions and one or more said light splitting surfaces, and the light incidence portions are in one-to-one correspondence with the light splitting surfaces.
